(19) United States
(12) Patent Application Publication
(10) Pub. No.: US 2026/0117122 A1
(43) Pub. Date: Apr. 30, 2026

(54) TRANSITION METAL ELEMENT-DOPED GARNET-TYPE ALUMINATE SCINTILLATION MATERIAL WITH HIGH-QUALITY FACTOR AND PREPARATION METHOD AND APPLICATION THEREOF

(71) Applicant: SHANGHAI INSTITUTE OF CERAMICS, CHINESE ACADEMY OF SCIENCES, Changning District, Shanghai (CN)

(72) Inventors: Dongzhou DING, Shanghai (CN); Aochen ZHANG, Shanghai (CN); Shuwen ZHAO, Shanghai (CN); Xiang ZHENG, Shanghai (CN); Zhongjun XUE, Shanghai (CN); Chengyi LI, Shanghai (CN); Peng QIU, Shanghai (CN)

(21) Appl. No.: 18/733,119

(22) Filed: Jun. 4, 2024

(30) Foreign Application Priority Data
Aug. 21, 2023 (CN) 202311050925.2

(51) Int. Cl. C09K 11/77

(52) U.S. Cl. CPC C09K 11/7774

(57) ABSTRACT

The present invention relates to a transition metal element-doped garnet-type aluminate scintillation material with high-quality factor and preparation method and application thereof. The transition metal element-doped garnet-type aluminate scintillation material has a chemical formula of RE₃₋ₓ₋ₐCeₓAₐAl_{5-y-z}D_{y}M_{z}O₁₂, wherein 0<x≤0.15, 0≤y≤3, 0<z≤0.1, and 0≤a≤0.1; RE is a rare earth element selected from at least one of Gd, Lu, Y, Sc, La, Nd, Eu, Tb, Dy, Ho, Er, Tm, and Yb; A is selected from at least one of Li, Mg, Ca, K, and Na; D is selected from at least one of Ga and In; and M is a transition element selected from at least one of Cr, Mn, Fe, Co, and Ni.

### TECHNICAL FIELD

The present invention relates to a garnet-type aluminate scintillation material with high-quality factor doped with transition metal element(s) having an ionic radius and electronegativity similar to that of Al³⁺ and a preparation method and application thereof, which belong to the technical field of scintillation materials.

### BACKGROUND

Inorganic scintillation materials are a kind of energy converter which can convert the energy of high energy photons (X or γ-rays) or particles (protons, neutrons, etc.) into ultraviolet/visible photons. Coupling inorganic scintillation materials with subsequent photoelectric conversion devices (photodiodes, silicon photomultiplier tubes, photomultiplier tubes, etc.) enables effective detection of nuclear radiation. X or γ rays generated by radioactive sources are incident on a scintillator, the rays are absorbed by the scintillator to produce scintillating light, an optical detector transforms an optical signal into an electrical signal, and then the electrical signals are collected, stored, and displayed, thus realizing an accurate measurement of many physical parameters such as energy, momentum, direction, and duration of such invisible high-energy rays or particles. Nowadays, detectors made of inorganic scintillation crystals are widely used in high-energy physics, space physics, industrial non-destructive flaw detection, security audit, mineral and oil well exploration, nuclear medicine imaging (X-ray computed tomography (X-CT), time-of-flight positron emission tomography (TOF-PET)), and many other fields, are the mainstream of scintillation material development, and have huge market potential.

With rapid development of nuclear detection and related technologies, higher requirements have been put forward for the performance of scintillation crystals. Traditional scintillation crystals such as NaI:Tl, CsI:Tl, Bi₄Ge₃O₁₂ (BGO), BaF₂, PbWO₄ (PWO), etc., cannot meet application requirements. Thus the development of scintillation crystals with high density, large atomic number, high light output, fast attenuation, and anti-irradiation has always been a goal pursued by researchers. The new generation of garnet-type aluminate scintillation crystals has gradually become a research hotspot due to their high light output, good energy resolution, and fast decay rate.

Rare-earth-element-doped garnet-type aluminates can be viewed as a regular tetrahedron and a regular octahedron interconnected in space by top-angle oxygen ions, and the resulting void is a distorted dodecahedron. In one unit, there are eight molecules with a stoichiometric formula of [A³⁺]₃[B³⁺]₂[Y³⁺]₃O₁₂. Y³⁺ is within a tetrahedron composed of four oxygen ions, B³⁺ is within an octahedron composed of six oxygen ions, and A³⁺ is within a distorted dodecahedron formed by gaps between the regular tetrahedron and the regular octahedron. Some trivalent rare-earth ions, such as Ce³⁺, when doped, generally enter a site of the dodecahedron. Ce³⁺-doped gadolinium aluminum gallate scintillator crystals (Gd₃Al₂Ga₃O₁₂:Ce, GAGG:Ce) have been developed in recent years under the guidance of the “bandgap engineering,” which uses rare earth ion Ce³⁺ as an activator, and takes advantage of 5d→4f parity of Ce³⁺ to obtain a fast-decaying luminescence. The crystal has characteristics of high light output, fast luminescence decay, large effective atomic number, high density, no self-radiation, no deliquescence, an excellent comprehensive performance, great development prospects, etc. With the further development of PET technology, the introduction of TOF technology has been proposed to improve imaging resolution, reduce the dose to patient, and shorten a scanning time. However, TOF technology requires scintillators with a faster scintillation decay time and higher light yield, which corresponds to a higher imaging resolution and positioning accuracy.

The GAGG:Ce crystals have a fast scintillation decay time component of about 90 ns. Although the decay time is significantly accelerated compared to that of conventional bismuth germanate (Bi₄Ge₃O₁₂, BGO), a shorter scintillation decay time is needed for practical applications. In order to accelerate the scintillation decay rate of GAGG:Ce crystals, Patent Document 1 (Application Publication No. WO2014/171985A2) discloses a method to improve the scintillation and optical properties of GAGG by doping at sites of rare earth lattice as well as adjusting the Al—Ga ratio. In addition to matrix component adjustment, ion co-doping is also the most commonly used means to modulate the scintillation performance. Wu et al. shortened the scintillation decay time of GAGG:Ce crystals by co-doping Ca²⁺ and converting part of the Ce³⁺ into the Ce⁴⁺ through a charge-balancing mechanism, and yet both of optical yield and energy resolution deteriorated to some extent (Physical Review Applied, 2014, 2(4), 044009.). Kamada et al. reported that Mg²⁺ co-doping can significantly shorten the scintillation decay time and has a superior effect compared to Ca²⁺ co-doping (Optical Materials, 2015, 41, 63.). Patent Document 2 (Application Publication No. WO2017/059832A1) discloses a method to shorten the scintillation response time by co-doping at the sites of rare earth lattice, but Patent Document 2 did not explore the effect of co-doping ions at Al sites at the time. Patent Document 3 (Chinese Publication No. CN115322784A) disclosed an improved gadolinium aluminum gallate scintillation material by doping at the sites of octahedral lattice and preparation method and application thereof, wherein at least one of Hf, Zr, Cu, Zn, Sn, Pb, Ti, Te, and Tb is co-doped at Al sites. Patent Document 3 mainly relies on the space structure modification by co-doping with an element having an ion radius between Gd³⁺ and Al³⁺ so that the co-doped element is preferentially distributed in the lattice site of an octahedron around the luminescence center Ce³⁺, to inhibit the formation of antisite defects, thereby accelerating the decay process. Patent Document 3 does not consider whether the electron arrangement outside the nucleus of the ion affects Ce³⁺ in the crystal, nor does it consider the presence of Ce⁴⁺. And after co-doping the above ions, the quality factor is slightly improved, but the improvement is not obvious.

### SUMMARY

In accordance with practical application needs, the purpose of the present invention is to provide a garnet-type aluminate scintillation material doped with a transition metal element having an ionic radius and electronegativity similar to that of Al³⁺ and an extra-nuclear electron arrangement of [Ar]3dⁿ4s^{1˜2}(n≥5), as well as a preparation method and an application thereof.

In a first aspect, the present invention provides a transition metal element-doped garnet-type aluminate scintillator material. The transition metal element-doped garnet-type aluminate scintillation material has a chemical formula of RE₃₋ₓ₋ₐCeₓAₐAl_{5-y-z}D_{y}M_{z}O₁₂, wherein 0<x≤0.15, 0≤y≤3, 0<z≤0.1, and 0≤a≤0.1; RE is a rare earth element selected from at least one of Gd, Lu, Y, Sc, La, Nd, Eu, Tb, Dy, Ho, Er, Tm, and Yb; A is selected from at least one of Li, Mg, Ca, K, and Na; D is selected from at least one of Ga and In; and M is a transition metal element selected from at least one of Cr, Mn, Fe, Co, and Ni.

In the present invention, transition metal elements with an ionic radius and electronegativity similar to that of Al³⁺ are co-doped, and these transition metal elements (at least one of Cr, Mn, Fe, Co, Ni) preferentially occupy Al sites compared to Gd, and their ionic radius and electronegativity are more similar to those of Al³⁺, with less effect on the surrounding crystal field. At the same time, these transition metal elements have an extra-nuclear electron arrangement of [Ar]3dⁿ4s^{1˜2} (n≥5), and Ce atoms have an extra-nuclear electron arrangement of [Xe]4f¹5d¹6s². When co-doped atoms and Ce atoms approach each other, Ce tends to form a stable +4 valence, thereby accelerating the scintillation decay and improving the quality factor. By doping with a transition metal element, a faster luminescence decay rate can be achieved, including at least one of reduction in the decay time of photoluminescence or scintillation luminescence. More preferably, in addition to a faster decay time, there is also at least one of the following technical effects: improved light yield, better energy resolution, and reduced afterglow. A novel scintillation material with a high-quality factor and an ultra-fast luminescence performance prepared by the present invention, can better meet the needs for use in high-energy physics, space physics, industrial non-destructive flaw detection, security auditing, mineral and oil well exploration, and nuclear medicine imaging (X-CT, TOF-PET).

Preferably, 0.00001≤z≤0.05.

Preferably, 0.001<x≤0.05.

Preferably, the transition metal element-doped garnet-type aluminate scintillator material is a polycrystal, a ceramic, or a single crystal.

In a second aspect, the invention provides a method for preparing a transition metal element-doped garnet-type aluminate scintillation material. The transition metal element-doped garnet-type aluminate scintillation material has a chemical formula of RE₃₋ₓ₋ₐCeₓAₐAl_{5-y-z}D_{y}M_{z}O₁₂, wherein 0<x≤0.15, 0≤y≤3, 0<z≤0.1, and 0≤a≤0.1; RE is a rare earth element selected from at least one of Gd, Lu, Y, Sc, La, Nd, Eu, Tb, Dy, Ho, Er, Tm, and Yb; A is selected from at least one of Li, Mg, Ca, K, and Na; D is selected from at least one of Ga and In; and M is a transition metal element selected from at least one of Cr, Mn, Fe, Co, and Ni.

When the transition metal element-doped garnet-type aluminate scintillation material is a polycrystal, the preparation method comprises (1) weighing CeO₂, Al₂O₃, an oxide of RE, an oxide of D, and an oxide of M as raw materials according to the chemical formula and mixing to obtain a mixed powder; and (2) subjecting the mixed powder to solid-phase reaction to obtain a transition metal element-doped garnet-type aluminate scintillation polycrystal. A solid-phase reaction temperature is 1,200 to 2,000° C., and solid-phase reaction time is 5 to 200 hours.

When the transition metal element-doped garnet-type aluminate scintillator material is a ceramic, the preparation method comprises (1) weighing CeO₂, Al₂O₃, an oxide of RE, an oxide of D, and an oxide of M as raw materials according to the chemical formula and mixing to obtain a mixed powder; and (2) forming the mixed powder to a green body and then sintering to obtain a transition metal element-doped garnet-type aluminate scintillation ceramic. A forming method of the green body includes at least one of dry pressing and cold isostatic pressing; preferably, the dry pressing has a pressure of 10 to 35 MPa and the cold isostatic pressing has a pressure of 2 to 5 GPa; sintering is at least one of pressureless sintering, hot pressure sintering, and hot isostatic pressure sintering; and preferably, a pressureless sintering temperature is 1,200 to 2,000° C., and a pressureless sintering time is 5 to 200 hours.

When the transition metal element-doped garnet-type aluminate scintillator material is a single crystal, the preparation method comprises (1) weighing CeO₂, Al₂O₃, an oxide of RE, an oxide of D, and an oxide of M as raw materials according to the chemical formula and mixing to obtain a mixed powder; and (2) melting the mixed powder by heating and growing to give a transition metal element-doped garnet-type aluminate scintillation single crystal. A growth method of the single crystal includes one of Czochralski method, Bridgman method, Temperature Gradient (TGT) method, Heat-Exchange method, Kyropoulos method, Top-Seeded Solution Growth (TSSG) method, Flux Crystal Growth method, and Micro-Pulling-Down method, and a heating method is resistance heating, electromagnetic induction heating, or optical heating.

Preferably, the preparation method comprises subjecting the raw materials to pre-firing prior to the mixing, a pre-firing temperature is 1,100° C., and a pre-firing time is 20 hours.

In a third aspect, the present invention provides an application of the transition metal element doped garnet-type aluminate scintillator material in high-energy physics, space physics, industrial non-destructive flaw detection, safety auditing, mineral and oil well exploration, or nuclear medicine imaging (X-CT, TOF-PET).

### Beneficial Effect of the Present Invention

1. The present invention proposes a technical solution of a garnet-type aluminate scintillator material doped with transition metal elements having ionic radius and electronegativity similar to that of Al³⁺, and select suitable doping ions based on reasonable predictions and experimental verification;
2. In the present invention, after doping transition metal elements in the garnet-type aluminate scintillator material, the luminescent properties of the material is significantly improved, including but not limited to a significant increase in the quality factor related to scintillation performance (light yield/scintillation decay time), a reduction in the scintillation rise time or decay time, and a significant reduction in the level of afterglow;
3. In the present invention, a scintillation material with a high-quality factor obtained by doping a garnet-type aluminate scintillation material with transition metal elements can be better applied to high-energy physics, space physics, industrial non-destructive flaw detection, safety auditing, mineral and oil well exploration, and nuclear medicine imaging (X-CT, TOF-PET).

### BRIEF DESCRIPTION OF THE DRAWINGS

FIG. 1 shows a scintillation decay time spectrum of a single crystal of Example 18.

FIG. 2 reveals a multi-channel spectrum of a single crystal of Example 18.

FIG. 3 shows an X-ray excited luminescence (XEL) of a single crystal of Example 18.

FIG. 4 shows an afterglow decay spectrum of a single crystal of Example 18.

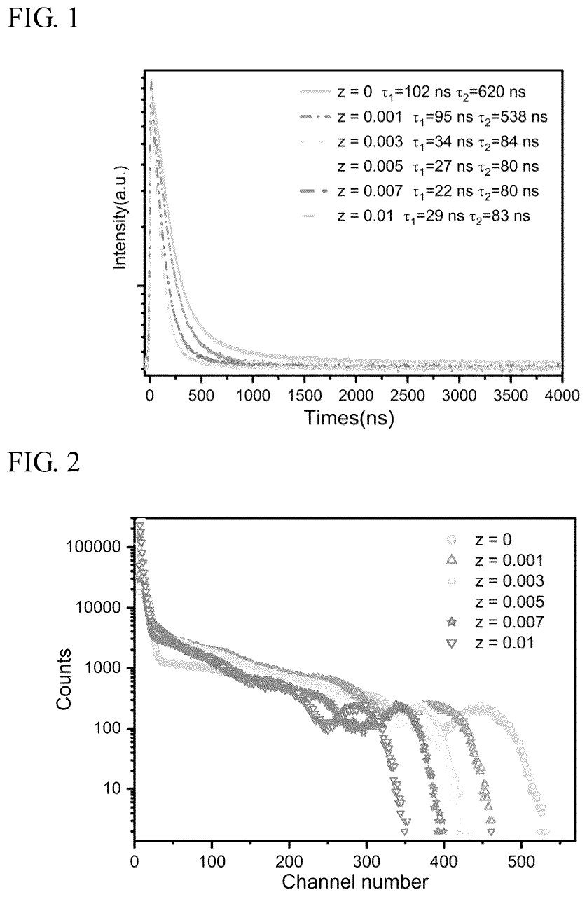

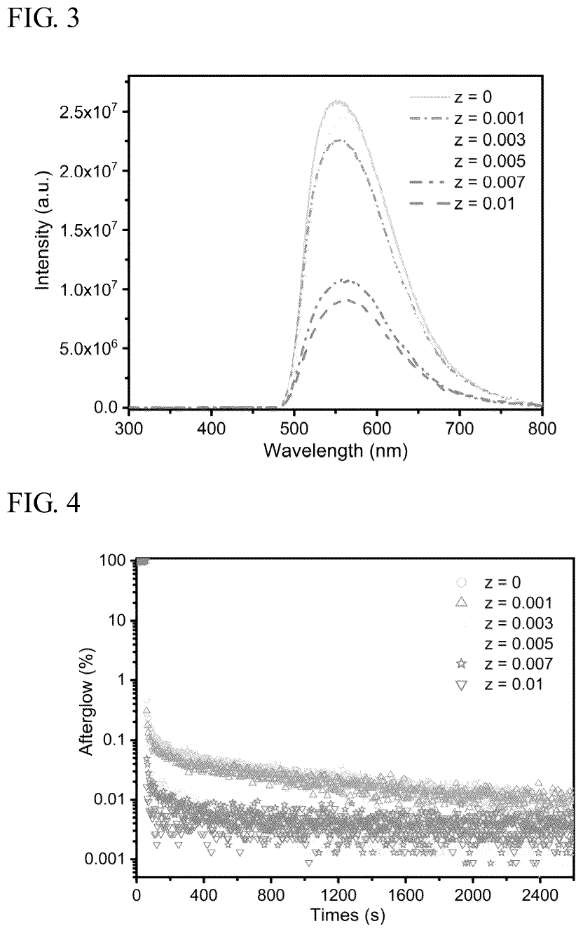

### DETAILED DESCRIPTION OF ILLUSTRATIVE EMBODIMENTS

The present invention will be further illustrated by the following embodiments. It should be understood that the following embodiments are only used to illustrate the present invention, but are not a limitation of the present invention.

In the present disclosure, transition metal elements with radius, ionic radius, and electronegativity similar to that of Al³⁺, such as Cr, Mn, Fe, Co, Ni, etc., are co-doped in GAGG:Ce. The doped elements preferentially occupy Al site compared to Gd, and have ionic radius, electronegativity, etc., more similar to that of Al, and have less effect on the surrounding crystal field. At the same time, the extra-nuclear electron arrangement of these transition metal elements is [Ar]3dⁿ4s^{1˜2} (n≥5), and the extra-nuclear electron arrangement of Ce atoms is [Xe]4f¹5d¹6s², and when co-doped atoms and Ce atoms approach each other, Ce has a tendency to form a stable +4 valence, which accelerates the scintillation attenuation, and significantly improves the quality factor. This method is generally applicable to garnet-type aluminate scintillator materials, which is of great significance for improving the scintillation performance of garnet-type aluminate scintillator materials and is expected to obtain new component materials with excellent performance.

Moreover, the present invention is accompanied by at least one of a shortening of the scintillation rise time, a significant reduction of the afterglow level, a superior energy resolution, and a stronger fluorescence emission intensity or X-ray excitation emission intensity, in addition to achieving a significant enhancement of the quality factor. If a z value is too high, a deterioration in the performance of the quality factor, the energy resolution, the afterglow, the fluorescence emission intensity, or the X-ray excitation emission intensity occurs.

In the present disclosure, the chemical formula of the transition metal element-doped garnet-type aluminate scintillation material is: RE₃₋ₓ₋ₐCeₓAₐAl_{5-y-z}D_{y}M_{z}O₁₂, wherein 0<x≤0.15, 0≤y≤3, 0<z≤0.1, and 0≤a≤0.1. Wherein, rare earth element RE is selected from at least one of Gd, Lu, Y, Sc, La, Nd, Eu, Tb, Dy, Ho, Er, Tm, and Yb; D is selected from no more than one of Ga and In; M is a co-doped element selected from at least one of Cr, Mn, Fe, Co, and Ni. In optional embodiments, an additional A element dopant may be doped to the RE₃₋ₓCeₓAl_{5-y-z}D_{y}M_{z}O₁₂ and enter into the site of rare earth RE lattice, wherein, the A element specifically comprises at least one of Li, Mg, Ca, K, and Na. Preferably, the transition metal element-doped improved garnet-type aluminate scintillation material is a polycrystalline powder or ceramic or single crystal.

In optional embodiments, when RE is Gd, D is Ga, and M is Cr, 0.003≤z≤0.05; when RE is Gd, D is Ga, and M is Mn, 0.0002≤z≤0.05; when RE is Gd, D is Ga, and M is Fe, 0.003≤z≤0.05; when RE is Gd, D is Ga, and M is Co, 0.003≤z≤0.05; when RE is Gd, D is Ga, M is Ni, 0.001≤z≤0.05.

In optional embodiments, when RE is Lu, M is Cr, 0.001≤z≤0.05; when RE is Lu, M is Mn, 0.0004≤z≤0.05; when RE is Lu, M is Fe, 0.003≤z≤0.05; when RE is Lu, M is Co, 0.001≤z≤0.05; when RE is Lu, M is Ni, 0.0006≤z≤0.05.

In optional embodiments, when RE is Y, M is Cr, 0.003≤z≤0.05; when RE is Y, M is Mn, 0.0004≤z≤0.05; when RE is Y, M is Fe, 0.001≤z≤0.05; when RE is Y, M is Co, 0.0006≤z≤0.05; when RE is Y, M is Ni, 0.0006≤z≤0.05.

The preparation method of the transition metal element-doped improved garnet-type aluminate scintillation material is exemplarily described below. The resulting transition metal element-doped improved garnet-type aluminate scintillation material is a polycrystalline powder or a ceramic or a single crystal. The ceramic includes transparent ceramics and non-transparent ceramics.

CeO₂, Al₂O₃, rare earth oxide(s) (REₘOₙ), and oxide(s) of Ga or In (D₂O₃) are used as raw materials, and are weighed (dosed) in accordance with the molar amount ratios of the raw material components, REₘOₙ:CeO₂:Al₂O₃:D₂O₃=(3-x)/m:x:(5-y-z)/2:y/2. The raw materials are mixed thoroughly and homogeneously to obtain a mixed powder. The purity of all raw materials used is 99.99% (4N) and above. Preferably, the initial raw materials before dosing are placed in a muffle furnace and calcined under air atmosphere at 1,100° C. for 20 hours to remove adsorbed water, crystal water, and some organic matter (e.g. possible residual oxalate ions in rare earth raw materials, etc.) from the raw materials.

The mixed powder may be directly calcined at 1,200 to 2,000° C. for 5 to 200 hours for solid phase reaction to give a polycrystalline powder. Preferably, the solid-phase reaction temperature is 1,400 to 1,600° C., and solid-phase reaction time is 10 to 50 hours. In an optional embodiment, the preparation method also comprises: crushing and grinding the resulting ceramic and single crystal into powder.

The mixed powder can be directly pressed into a block by cold isostatic pressing (with a pressure of 2 to 5 GPa) and then sintered at 1,200 to 2,000° C. for 5 to 200 hours to obtain a ceramic. Alternatively, a transparent ceramic can be prepared by adjusting the sintering process, such as using hot press sintering or vacuum sintering. Wherein, the pressure for pressing into a block may be 2 to 5 GPa. Preferably, the solid phase reaction temperature may be 1,400 to 1,600° C., and the solid phase reaction time may be 10 to 50 hours.

A single crystal is prepared by using a mixed powder or polycrystalline powder, placing in a container, melting by heating (resistance or electromagnetic induction or light, etc.), and slowly crystallizing from the melt. Specific methods include the Czochralski method, Bridgman method, Temperature Gradient (TGT) method, Heat-Exchange method, Kyropoulos method, Top-Seeded Solution growth (TSSG) method, Fluxing Agent Crystal growth method, and Micro-Pulling-Down (μ-PD) method for growth. The container used can be a graphite crucible, an iridium crucible, a molybdenum crucible, a tungsten-molybdenum crucible, a rhenium crucible, a tantalum crucible, an alumina crucible, or a zirconium oxide crucible. The atmosphere for single crystal growth may be one or a mixture of air, argon, nitrogen, carbon dioxide, and carbon monoxide. In an optional embodiment, the single crystal is grown by the Czochralski method, the container is an iridium crucible, the heating method is induction heating, the growth atmosphere is high-purity nitrogen, and pulling is accompanied by rotating; more preferably, the pulling speed of the single crystal growth by Czochralski method is 0.7 to 6.0 mm/h, and the rotational speed is 3 to 15 r/min.

In the present disclosure, in the process of preparing a transition metal element-doped garnet-type aluminate scintillator material, an extremely low amount of doping element M can be doped into the sites of rare earth RE, but it is difficult to derive an accurate doping content due to technological constraints and conventional characterization means. Of course, the extremely low amount of doping element M doped to the site of rare earth RE for the material itself, there will be no essential change in the performance. Moreover, the resulting transition metal element-doped garnet-type aluminate scintillator material with high quality factor can be better used in high-energy physics, space physics, industrial non-destructive testing, security auditing, mineral and oil well exploration, and nuclear medicine imaging (X-CT, TOF-PET).

The following examples are further given to illustrate the present invention in detail. It should also be understood that the following examples are only used to further illustrate the present invention, and cannot be understood as limiting the scope of protection of the present invention. Some non-essential improvements and adjustments made by those skilled in the art according to the above contents of the present invention belong to the scope of protection of the present invention. The specific process parameters in the following examples are only one example in the appropriate range, that is, those skilled in the art can choose from the appropriate range through the description herein, and are not limited to the specific values in the following examples.

### Example 1 (Growth of Cr Doped GAGG:Ce Single Crystals by the Czochralski Method)

Single crystals were grown using the Czochralski method. Raw materials were weighed according to the molar ratio of Gd₂O₃:CeO₂:Al₂O₃:Ga₂O₃:Cr₂O₃=1.485:0.03:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1). The raw materials were mixed uniformly, and the resulting mixture was pressed into a block by cold isostatic pressing with a pressure of 3 GPa. The pressed block was placed into an iridium crucible, under a protective atmosphere of nitrogen, subjected to induction heating, and sufficiently melted. Then, single crystals with a predetermined size were slowly pulled and grown from the melt after seed crystal inoculation, ultimately obtaining Gd_{2.97}Ce_{0.03}Al_{2.3-z}Ga_{2.7}Cr_{z}O₁₂ single crystals. Wherein, the parameters of the Czochralski method include: a required size design, a temperature field design, a PID quality control temperature, a pulling speed of 0.7 to 6.0 mm/h, and a rotational speed of 3 to 15 r/min.

### Example 2 (Growth of Cr Doped GAGG:Ce Single Crystals by the Micro-Pulling-Down Method)

Single crystals were grown by the Micro-Pulling-Down method. Raw materials were weighed according to the molar ratio of Gd₂O₃:CeO₂:Al₂O₃:Ga₂O₃:Cr₂O₃=1.4925:0.015:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1). The raw materials were mixed uniformly, and the resulted mixture was pre-sintered in a muffle furnace at 1,450° C. The pre-sintered raw material was placed into an iridium crucible, subjected to induction heating, and fully melted under a protective atmosphere of nitrogen. After the seed crystals came into contact with the melt, it is slowly pulled down to obtain Gd_{2.985}Ce_{0.015}Al_{2.3-z}Ga_{2.7}Cr_{z}O₁₂ single crystals. Wherein, the parameters of the Micro-Pulling-Down method include: a required size design, a temperature field design, and a Micro-Pulling-Down speed of 3 to 20 mm/h.

### Example 3 (Preparation of Cr Doped GAGG:Ce Polycrystalline Powder)

The raw materials were weighed according to Example 2, and mixed uniformly. The resulting mixture was placed into a corundum crucible, and calcined in a muffle furnace at 1,600° C. for 10 hours for sufficient solid-phase reaction to obtain Gd_{2.985}Ce_{0.015}Al_{2.3-z}Ga_{2.7}Cr_{z}O₁₂ polycrystalline powder.

### Example 4 (Preparation of Cr Doped GAGG:Ce Ceramics)

Non-transparent: The raw materials were weighed according to Example 2, and mixed uniformly. The resulting mixture was pressed into a block by cold isostatic pressing with a pressure of 3 GPa. The pressed block was loaded into a corundum crucible and sintered in a muffle furnace at 1,600° C. for 10 hours for sufficient solid-phase reaction to obtain Gd_{2.985}Ce_{0.015}Al_{2.3-z}Ga_{2.7}Cr_{z}O₁₂ non-transparent ceramics.

Transparent: The raw materials were weighed according to Example 2, and mixed uniformly. The resulting mixture was pressed by cold isostatic pressing with a pressure of 3 GPa, and then a sufficient solid-phase reaction was carried out in a vacuum hot-pressing furnace (1,600° C., 50 hours) to exclude bubbles and voids as much as possible to obtain Gd_{2.985}Ce_{0.015}Al_{2.3-z}Ga_{2.7}Cr_{z}O₁₂ transparent ceramics.

### Example 5 (Growth of Mn Doped GAGG:Ce Single Crystals by the Czochralski Method)

Raw materials were weighed according to the molar amount ratio of Gd₂O₃:CeO₂:Al₂O₃:Ga₂O₃:Mn₂O₃=1.485:0.03:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Gd_{2.97}Ce_{0.03}Al_{2.3-z}Ga_{2.7}Mn_{z}O₁₂ single crystals.

### Example 6 (Growth of Mn Doped GAGG:Ce Single Crystals by the Micro-Pulling-Down Method)

Raw materials were weighed according to the molar amount ratio of Gd₂O₃:CeO₂:Al₂O₃:Ga₂O₃:Mn₂O₃=1.4925:0.015:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Gd_{2.985}Ce_{0.015}Al_{2.3-z}Ga_{2.7}Mn_{z}O₁₂ single crystals.

### Example 7 (Preparation of Mn Doped GAGG:Ce Polycrystalline Powder)

Raw materials were weighed according to Example 6, and the subsequent steps were the same as in Example 3 to obtain Gd_{2.985}Ce_{0.015}Al_{2.3-z}Ga_{2.7}Mn_{z}O₁₂ polycrystalline powder.

### Example 8 (Preparation of Mn Doped GAGG:Ce Ceramics)

Raw materials were weighed according to Example 6 and the subsequent steps were the same as in Example 4 to obtain Gd_{2.985}Ce_{0.015}Al_{2.3-z}Ga_{2.7}Mn_{z}O₁₂ non-transparent ceramics and transparent ceramics.

### Example 9 (Growth of Fe Doped GAGG:Ce Single Crystals by the Czochralski Method)

Raw materials were weighed according to the molar amount ratio of Gd₂O₃:CeO₂:Al₂O₃:Ga₂O₃:Fe₂O₃=1.485:0.03:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Gd_{2.97}Ce_{0.03}Al_{2.3-z}Ga_{2.7}Fe_{z}O₁₂ single crystals.

### Example 10 (Growth of Fe Doped GAGG:Ce Single Crystals by the Micro-Pulling-Down Method)

Raw materials were weighed according to the molar amount ratio of Gd₂O₃:CeO₂:Al₂O₃:Ga₂O₃:Fe₂O₃=1.4925:0.015:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Gd_{2.985}Ce_{0.015}Al_{2.3-z}Ga_{2.7}Fe_{z}O₁₂ single crystals.

### Example 11 (Preparation of Fe Doped GAGG:Ce Polycrystalline Powder)

Raw materials were weighed according to Example 10, and the subsequent steps were the same as in Example 3 to obtain Gd_{2.985}Ce_{0.015}Al_{2.3-z}Ga_{2.7}Fe_{z}O₁₂ polycrystalline powder.

### Example 12 (Preparation of Fe Doped GAGG:Ce Ceramics)

Raw materials were weighed according to Example 10, and the subsequent steps were the same as in Example 4, to obtain Gd_{2.985}Ce_{0.015}Al_{2.3-z}Ga_{2.7}Fe_{z}O₁₂ non-transparent ceramics and transparent ceramics.

### Example 13 (Growth of Co Doped GAGG:Ce Single Crystals by the Czochralski Method)

Raw materials were weighed according to the molar amount of Gd₂O₃:CeO₂:Al₂O₃:Ga₂O₃:CoO=1.485:0.03:(2.3-z)/2:1.35:z(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Gd_{2.97}Ce_{0.03}Al_{2.3-z}Ga_{2.7}Co_{z}O₁₂ single crystals.

### Example 14 (Growth of Co Doped GAGG:Ce Single Crystals by the Micro-Pulling-Down Method)

Raw materials were weighed according to the molar amount ratio of Gd₂O₃:CeO₂:Al₂O₃:Ga₂O₃:CoO=1.4925:0.015:(2.3-z)/2:1.35:z(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Gd_{2.985}Ce_{0.015}Al_{2.3-z}Ga_{2.7}Co_{z}O₁₂ single crystals.

### Example 15 (Preparation of Co Doped GAGG:Ce Polycrystalline Powder)

Raw materials were weighed according to Example 14, and the subsequent steps were the same as in Example 3 to obtain Gd_{2.985}Ce_{0.015}Al_{2.3-z}Ga_{2.7}Co_{z}O₁₂ polycrystalline powder.

### Example 16 (Preparation of Co Doped GAGG:Ce Ceramics)

Raw materials were weighed according to Example 14, and the subsequent steps were the same as in Example 4 to obtain Gd_{2.985}Ce_{0.015}Al_{2.3-z}Ga_{2.7}Co_{z}O₁₂ non-transparent ceramics and transparent ceramics.

### Example 17 (Growth of Ni Doped GAGG:Ce Single Crystals by the Czochralski Method)

Raw materials were weighed according to the molar amount ratio of Gd₂O₃:CeO₂:Al₂O₃:Ga₂O₃:Ni₂O₃=1.485:0.03:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Gd_{2.97}Ce_{0.03}Al_{2.3-z}Ga_{2.7}Ni_{z}O₁₂ single crystals.

### Example 18 (Growth of Ni Doped GAGG:Ce Single Crystals by the Micro-Pulling-Down Method)

Raw materials were weighed according to the molar amount ratio of Gd₂O₃:CeO₂:Al₂O₃:Ga₂O₃:Ni₂O₃=1.4925:0.015:(2.3-z)/2:1.35:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Gd_{2.985}Ce_{0.015}Al_{2.3-z}Ga_{2.7}Ni_{z}O₁₂ single crystals.

### Example 19 (Preparation of Ni Doped GAGG:Ce Polycrystalline Powder)

Raw materials were weighed according to Example 18, and the subsequent steps were the same as in Example 3 to obtain Gd_{2.985}Ce_{0.015}Al_{2.3-z}Ga_{2.7}Ni_{z}O₁₂ polycrystalline powder.

### Example 20 (Preparation of Ni Doped GAGG:Ce Ceramics)

Raw materials were weighed according to Example 18, and the subsequent steps were the same as in Example 4 to obtain Gd_{2.985}Ce_{0.015}Al_{2.3-z}Ga_{2.7}Ni_{z}O₁₂ non-transparent ceramics and transparent ceramics.

### Example 21 (Growth of Cr Doped LuAG:Ce Single Crystals by the Czochralski Method)

Raw materials were weighed according to the molar amount ratio of Lu₂O₃:CeO₂:Al₂O₃:Cr₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Lu_{2.97}Ce_{0.03}Al_{5-z}Cr_{z}O₁₂ single crystals.

### Example 22 (Growth of Cr Doped LuAG:Ce Single Crystals by the Micro-Pulling-Down Method)

Raw materials were weighed according to the molar amount ratio of Lu₂O₃:CeO₂:Al₂O₃:Cr₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Lu_{2.985}Ce_{0.015}Al_{5-z}Cr_{z}O₁₂ single crystals.

### Example 23 (Preparation of Cr Doped LuAG:Ce Polycrystalline Powder)

Raw materials were weighed according to Example 22, and the subsequent steps were the same as in Example 3 to obtain Lu_{2.985}Ce_{0.015}Al_{5-z}Cr_{z}O₁₂ polycrystalline powder.

### Example 24 (Preparation of Cr Doped LuAG:Ce Ceramics)

Raw materials were weighed according to Example 22, and the subsequent steps were the same as in Example 4 to obtain Lu_{2.985}Ce_{0.015}Al_{5-z}Cr_{z}O₁₂ non-transparent ceramics and transparent ceramics.

### Example 25 (Growth of Mn Doped LuAG:Ce Single Crystals by the Czochralski Method)

Raw materials were weighed according to the molar amount ratio of Lu₂O₃:CeO₂:Al₂O₃:Mn₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Lu_{2.97}Ce_{0.03}Al_{5-z}Mn_{z}O₁₂ single crystals.

### Example 26 (Growth of Mn Doped LuAG:Ce Single Crystals by the Micro-Pulling-Down Method)

Raw materials were weighed according to the molar amount ratio of Lu₂O₃:CeO₂:Al₂O₃:Mn₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Lu_{2.985}Ce_{0.015}Al_{5-z}Mn_{z}O₁₂ single crystals.

### Example 27 (Preparation of Mn Doped LuAG:Ce Polycrystalline Powder)

Raw materials were weighed according to Example 26, and the subsequent steps were the same as in Example 3 to obtain Lu_{2.985}Ce_{0.015}Al_{5-z}Mn_{z}O₁₂ polycrystalline powder.

### Example 28 (Preparation of Mn Doped LuAG:Ce Ceramics)

Raw materials were weighed according to Example 26, and the subsequent steps were the same as in Example 4 to obtain Lu_{2.985}Ce_{0.015}Al_{5-z}Mn_{z}O₁₂ non-transparent ceramics and transparent ceramics.

### Example 29 (Growth of Fe Doped LuAG:Ce Single Crystals by the Czochralski Method)

Raw materials were weighed according to the molar ratio of Lu₂O₃:CeO₂:Al₂O₃:Fe₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Lu_{2.97}Ce_{0.03}Al_{5-z}Fe_{z}O₁₂ single crystals.

### Example 30 (Growth of Fe Doped LuAG:Ce Single Crystals by the Micro-Pulling-Down Method)

Raw materials were weighed according to the molar amount ratio of Lu₂O₃:CeO₂:Al₂O₃:Fe₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Lu_{2.985}Ce_{0.015}Al_{5-z}Fe_{z}O₁₂ single crystals.

### Example 31 (Preparation of Fe Doped LuAG:Ce Polycrystalline Powder)

Raw materials were weighed according to Example 30, and the subsequent steps were the same as in Example 3 to obtain Lu_{2.985}Ce_{0.015}Al_{5-z}Fe_{z}O₁₂ polycrystalline powder.

### Example 32 (Preparation of Fe Doped LuAG:Ce Ceramics)

Raw materials were weighed according to Example 30, and the subsequent steps were the same as in Example 4 to obtain Lu_{2.985}Ce_{0.015}Al_{5-z}Fe_{z}O₁₂ non-transparent ceramics and transparent ceramics.

### Example 33 (Growth of Co Doped LuAG:Ce Single Crystals by the Czochralski Method)

Raw materials were weighed according to the molar amount ratio of Lu₂O₃:CeO₂:Al₂O₃:CoO=1.485:0.03:(5-z)/2:z(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Lu_{2.97}Ce_{0.03}Al_{5-z}Co_{z}O₁₂ single crystals.

### Example 34 (Growth of Co Doped LuAG:Ce Single Crystals by the Micro-Pulling-Down Method)

Raw materials were weighed according to the molar ratio of Lu₂O₃:CeO₂:Al₂O₃:CoO=1.4925:0.015:(5-z)/2:z(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Lu_{2.985}Ce_{0.015}Al_{5-z}Co_{z}O₁₂ single crystals.

### Example 35 (Preparation of Co Doped LuAG:Ce Polycrystalline Powder)

Raw materials were weighed according to Example 34, and the subsequent steps were the same as in Example 3 to obtain Lu_{2.985}Ce_{0.015}Al_{5-z}Co_{z}O₁₂ polycrystalline powder.

### Example 36 (Preparation of Co Doped LuAG:Ce Ceramics)

Raw materials were weighed according to Example 34 and the subsequent steps were the same as in Example 4 to obtain Lu_{2.985}Ce_{0.015}Al_{5-z}Co_{z}O₁₂ non-transparent ceramics and transparent ceramics.

### Example 37 (Growth of Ni Doped LuAG:Ce Single Crystals by the Czochralski Method)

Raw materials were weighed according to the molar amount ratio of Lu₂O₃:CeO₂:Al₂O₃:Ni₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Lu_{2.97}Ce_{0.03}Al_{5-z}Ni_{z}O₁₂ single crystals.

### Example 38 (Growth of Ni Doped LuAG:Ce Single Crystals by the Micro-Pulling-Down Method)

Raw materials were weighed according to the molar amount ratio of Lu₂O₃:CeO₂:Al₂O₃:Ni₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Lu_{2.985}Ce_{0.015}Al_{5-z}Ni_{z}O₁₂ single crystals.

### Example 39 (Preparation of Ni Doped LuAG:Ce Polycrystalline Powder)

Raw materials were weighed according to Example 38, and the subsequent steps were the same as in Example 3 to obtain Lu_{2.985}Ce_{0.015}Al_{5-z}Ni_{z}O₁₂ polycrystalline powder.

### Example 40 (Preparation of Ni Doped LuAG:Ce Ceramics)

Raw materials were weighed according to Example 38 and the subsequent steps were the same as in Example 4 to obtain Lu_{2.985}Ce_{0.015}Al_{5-z}Ni_{z}O₁₂ non-transparent ceramics and transparent ceramics.

### Example 41 (Growth of Cr Doped YAG:Ce Single Crystals by the Czochralski Method)

Raw materials were weighed according to the molar amount ratio of Y₂O₃:CeO₂:Al₂O₃:Cr₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Y_{2.97}Ce_{0.03}Al_{5-z}Cr_{z}O₁₂ single crystals.

### Example 42 (Growth of Cr Doped YAG:Ce Single Crystals by the Micro-Pulling-Down Method)

Raw materials were weighed according to the molar amount ratio of Y₂O₃:CeO₂:Al₂O₃:Cr₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Y_{2.985}Ce_{0.015}Al_{5-z}Cr_{z}O₁₂ single crystals.

### Example 43 (Preparation of Cr Doped YAG:Ce Polycrystalline Powder)

Raw materials were weighed according to Example 42, and the subsequent steps were the same as in Example 3 to obtain Y_{2.985}Ce_{0.015}Al_{5-z}Cr_{z}O₁₂ polycrystalline powder.

### Example 44 (Preparation of Cr Doped YAG:Ce Ceramics)

Raw materials were weighed according to Example 42 and the subsequent steps were the same as in Example 4 to obtain Y_{2.985}Ce_{0.015}Al_{5-z}Cr_{z}O₁₂ non-transparent ceramics and transparent ceramics.

### Example 45 (Growth of Mn Doped YAG:Ce Single Crystals by the Czochralski Method)

Raw materials were weighed according to the molar amount ratio of Y₂O₃:CeO₂:Al₂O₃:Mn₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Y_{2.97}Ce_{0.03}Al_{5-z}Mn_{z}O₁₂ single crystals.

### Example 46 (Growth of Mn Doped YAG:Ce Single Crystals by the Micro-Pulling-Down Method)

Raw materials were weighed according to the molar amount ratio of Y₂O₃:CeO₂:Al₂O₃:Mn₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Y_{2.985}Ce_{0.015}Al_{5-z}Mn_{z}O₁₂ single crystals.

### Example 47 (Preparation of Mn Doped YAG:Ce Polycrystalline Powder)

Raw materials were weighed according to Example 46, and the subsequent steps were the same as in Example 3 to obtain Y_{2.985}Ce_{0.015}Al_{5-z}Mn_{z}O₁₂ polycrystalline powder.

### Example 48 (Preparation of Mn Doped YAG:Ce Ceramics)

Raw materials were weighed according to Example 46, and the subsequent steps were the same as in Example 4 to obtain Y_{2.985}Ce_{0.015}Al_{5-z}Mn_{z}O₁₂ non-transparent ceramics and transparent ceramics.

### Example 49 (Growth of Fe Doped YAG:Ce Single Crystals by the Czochralski Method)

Raw materials were weighed according to the molar amount ratio of Y₂O₃:CeO₂:Al₂O₃:Fe₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Y_{2.97}Ce_{0.03}Al_{5-z}Fe_{z}O₁₂ single crystals.

### Example 50 (Growth of Fe Doped YAG:Ce Single Crystals by the Micro-Pulling-Down Method)

Raw materials were weighed according to the molar amount ratio of Y₂O₃:CeO₂:Al₂O₃:Fe₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Y_{2.985}Ce_{0.015}Al_{5-z}Fe_{z}O₁₂ single crystals.

### Example 51 (Preparation of Fe Doped YAG:Ce Polycrystalline Powder)

Raw materials were weighed according to Example 50, and the subsequent steps were the same as in Example 3 to obtain Y_{2.985}Ce_{0.015}Al_{5-z}Fe_{z}O₁₂ polycrystalline powder.

### Example 52 (Preparation of Fe Doped YAG:Ce Ceramics)

Raw materials were weighed according to Example 50 and the subsequent steps were the same as in Example 4 to obtain Y_{2.985}Ce_{0.015}Al_{5-z}Fe_{z}O₁₂ non-transparent and transparent ceramics.

### Example 53 (Growth of Co Doped YAG:Ce Single Crystals by the Czochralski Method)

Raw materials were weighed according to the molar amount ratio of Y₂O₃:CeO₂:Al₂O₃:CoO=1.485:0.03:(5-z)/2:z(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Y_{2.97}Ce_{0.03}Al_{5-z}Co_{z}O₁₂ single crystals.

### Example 54 (Growth of Co Doped YAG:Ce Single Crystals by the Micro-Pulling-Down Method)

Raw materials were weighed according to the molar amount ratio of Y₂O₃:CeO₂:Al₂O₃:CoO=1.4925:0.015:(5-z)/2:z(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Y_{2.985}Ce_{0.015}Al_{5-z}Co_{z}O₁₂ single crystals.

### Example 55 (Preparation of Co Doped YAG:Ce Polycrystalline Powder)

Raw materials were weighed according to Example 54, and the subsequent steps were the same as in Example 3 to obtain Y_{2.985}Ce_{0.015}Al_{5-z}Co_{z}O₁₂ polycrystalline powder.

### Example 56 (Preparation of Co Doped YAG:Ce Ceramics)

Raw materials were weighed according to Example 54 and the subsequent steps were the same as in Example 4 to obtain Y_{2.985}Ce_{0.015}Al_{5-z}Co_{z}O₁₂ non-transparent and transparent ceramics.

### Example 57 (Growth of Ni Doped YAG:Ce Single Crystals by the Czochralski Method)

Raw materials were weighed according to the molar amount ratio of Y₂O₃:CeO₂:Al₂O₃:Ni₂O₃=1.485:0.03:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 1 to obtain Y_{2.97}Ce_{0.03}Al_{5-z}Ni_{z}O₁₂ single crystals.

### Example 58 (Growth of Ni Doped YAG:Ce Single Crystals by the Micro-Pulling-Down Method)

Raw materials were weighed according to the molar amount ratio of Y₂O₃:CeO₂:Al₂O₃:Ni₂O₃=1.4925:0.015:(5-z)/2:z/2(z=0.00001, 0.00005, 0.0001, 0.0002, 0.0004, 0.0006, 0.0008, 0.001, 0.002, 0.003, 0.005, 0.007, 0.01, 0.03, 0.05, 0.07, 0.1), and the subsequent steps were the same as in Example 2 to obtain Y_{2.985}Ce_{0.015}Al_{5-z}Ni_{z}O₁₂ single crystals.

### Example 59 (Preparation of Ni Doped YAG:Ce Polycrystalline Powder)

Raw materials were weighed according to Example 58, and the subsequent steps were the same as in Example 3 to obtain Y_{2.985}Ce_{0.015}Al_{5-z}Ni_{z}O₁₂ polycrystalline powder.

### Example 60 (Preparation of Ni Doped YAG:Ce Ceramics)

Raw materials were weighed according to Example 58, and the subsequent steps were the same as in Example 4 to obtain Y_{2.985}Ce_{0.015}Al_{5-z}Ni_{z}O₁₂ non-transparent ceramics and transparent ceramics.

Table 1 shows the relative light yield and quality factor (light yield/flicker decay time) for single crystals of Example 18.

| z | Relative light yield | Quality factor |
|---|---|---|
| z = 0 | 100% | 227 |
| z = 0.001 | 87.4% | 247 |
| z = 0.003 | 81.7% | 557 |
| z = 0.005 | 80.5% | 515 |
| z = 0.007 | 76.7% | 490 |
| z = 0.01 | 65.0% | 488 |

Table 2 shows the afterglow levels of single crystals of Example 18.

| | Afterglow level | Afterglow level | Afterglow level |
|---|---|---|---|
| z | @1 s /% | @200 s /% | @1500 s /% |
| z = 0 | 0.58 | 0.057 | 0.020 |
| z = 0.001 | 0.37 | 0.044 | 0.015 |
| z = 0.003 | 0.11 | 0.008 | 0.005 |
| z = 0.005 | 0.07 | 0.008 | 0.004 |
| z = 0.007 | 0.05 | 0.006 | 0.003 |
| z = 0.01 | 0.02 | 0.004 | 0.002 |

Table 3 shows the relative quality factors of non-transparent ceramics of Examples 4, 8, 12, 16, and 20 (compared to undoped non-transparent ceramic sheets).

| | Relative quality factor | | | | | | | | |
|---|---|---|---|---|---|---|---|---|---|
| | z = | z = | z = | z = | z = | z = | z = | z = | z = |
| M | 0.0002 | 0.0004 | 0.0006 | 0.001 | 0.003 | 0.005 | 0.007 | 0.01 | 0.05 |
| Cr | 1.02 | 1.03 | 1.05 | 1.09 | 1.19 | 1.13 | 1.10 | 1.07 | 1.03 |
| Mn | 1.19 | 1.34 | 1.43 | 1.35 | 1.27 | 1.16 | 1.12 | 1.08 | 1.05 |
| Fe | 1.01 | 1.03 | 1.05 | 1.11 | 1.36 | 1.33 | 1.25 | 1.10 | 1.03 |
| Co | 1.03 | 1.06 | 1.08 | 1.13 | 1.29 | 1.39 | 1.25 | 1.17 | 1.06 |
| Ni | 1.03 | 1.08 | 1.10 | 1.35 | 1.57 | 1.53 | 1.41 | 1.39 | 1.12 |
| undoped | 1 | | | | | | | | |
| z = 0 | | | | | | | | | |

Table 4 shows the relative quality factors of non-transparent ceramics of Examples 24, 28, 32, 36, 40 (compared to undoped non-transparent ceramic sheets).

| | Relative quality factor | | | | | | | | |
|---|---|---|---|---|---|---|---|---|---|
| | z = | z = | z = | z = | z = | z = | z = | z = | z = |
| M | 0.0002 | 0.0004 | 0.0006 | 0.001 | 0.003 | 0.005 | 0.007 | 0.01 | 0.05 |
| Cr | 1.01 | 1.04 | 1.09 | 1.14 | 1.10 | 1.09 | 1.07 | 1.05 | 1.02 |
| Mn | 1.05 | 1.29 | 1.43 | 1.28 | 1.19 | 1.18 | 1.13 | 1.10 | 1.06 |
| Fe | 1.01 | 1.02 | 1.05 | 1.06 | 1.26 | 1.23 | 1.14 | 1.08 | 1.04 |
| Co | 1.04 | 1.09 | 1.11 | 1.29 | 1.42 | 1.29 | 1.25 | 1.14 | 1.07 |
| Ni | 1.03 | 1.13 | 1.33 | 1.56 | 1.30 | 1.28 | 1.25 | 1.19 | 1.14 |
| undoped | 1 | | | | | | | | |
| z = 0 | | | | | | | | | |

Table 5 shows the relative quality factors of non-transparent ceramics of Examples 44, 48, 52, 56, and 60 (compared to undoped non-transparent ceramic sheets).

| | Relative quality factor | | | | | | | | |
|---|---|---|---|---|---|---|---|---|---|
| | z = | z = | z = | z = | z = | z = | z = | z = | z = |
| M | 0.0002 | 0.0004 | 0.0006 | 0.001 | 0.003 | 0.005 | 0.007 | 0.01 | 0.05 |
| Cr | 1.01 | 1.03 | 1.09 | 1.11 | 1.13 | 1.09 | 1.07 | 1.05 | 1.02 |
| Mn | 1.10 | 1.29 | 1.45 | 1.31 | 1.24 | 1.19 | 1.12 | 1.08 | 1.05 |
| Fe | 1.01 | 1.05 | 1.14 | 1.26 | 1.17 | 1.13 | 1.09 | 1.06 | 1.03 |
| Co | 1.03 | 1.09 | 1.21 | 1.36 | 1.29 | 1.25 | 1.14 | 1.10 | 1.06 |
| Ni | 1.02 | 1.09 | 1.24 | 1.33 | 1.41 | 1.27 | 1.25 | 1.20 | 1.11 |
| undoped | 1 | | | | | | | | |
| z = 0 | | | | | | | | | |

In the present invention, the GAGG:Ce is co-doped with transition metal elements having ionic radius and electronegativity similar to that of Al³⁺, such as Cr, Mn, Fe, Co, Ni, etc. The doped element preferentially occupies Al site compared to Gd, and the ionic radii and electronegativity are more similar to that of Al³⁺, which has a smaller effect on the surrounding crystal field. At the same time, the extra-nuclear electron arrangement of these transition metal elements is [Ar]3dⁿ4s^{1˜2} (n≥5) and the extra-nuclear electron arrangement of Ce atoms is [Xe]4f¹5d¹6s², and when co-doped atoms and Ce atoms approach each other, Ce has a tendency to form a stable +4-valence, which accelerates the scintillation decay and enhances the quality factor. The method has general applicability to garnet-type aluminum scintillation materials and can provide guidance for the design of new components.

The above examples are only for further illustration of the present invention, and should not be understood as limiting the protection scope of the present invention. Some non-essential modifications and adjustments thereof by those skilled in the art according to the above descriptions are within the protection scope of the present invention.

1. A transition metal element-doped garnet-type aluminate scintillator material having a chemical formula of RE₃₋ₓ₋ₐCeₓAₐAl_{5-y-z}D_{y}M_{z}O₁₂, wherein
0<x≤0.15,0≤y≤3,0<z≤0.1, and 0≤a≤0.1,
RE is a rare earth element selected from at least one of Gd, Lu, Y, Sc, La, Nd, Eu, Tb, Dy, Ho, Er, Tm, and Yb,
A is selected from at least one of Li, Mg, Ca, K, and Na,
D is selected from at least one of Ga and In, and
M is a transition metal element selected from at least one of Cr, Mn, Fe, Co, and Ni.

2. The transition metal element-doped garnet-type aluminate scintillation material according to claim 1, wherein 0.00001≤z≤0.05.

3. The transition metal element-doped garnet-type aluminate scintillation material according to claim 2, wherein 0.001<x≤0.05.

4. The transition metal element-doped garnet-type aluminate scintillation material according to claim 1, wherein the transition metal element-doped garnet-type aluminate scintillation material is a polycrystal, a ceramic, or a single crystal.

5. A preparation method for a transition metal element-doped garnet-type aluminate scintillator material having a chemical formula of RE₃₋ₓ₋ₐCeₓAₐAl_{5-y-z}D_{y}M_{z}O₁₂, wherein 0<x≤0.15, 0≤y≤3, 0<z≤0.1, and 0≤a≤0.1; RE is a rare earth element selected from at least one of Gd, Lu, Y, Sc, La, Nd, Eu, Tb, Dy, Ho, Er, Tm, and Yb; A is selected from at least one of Li, Mg, Ca, K, and Na; D is selected from at least one of Ga and In; and M is a transition metal element selected from at least one of Cr, Mn, Fe, Co, and Ni, the preparation method comprising:
when the transition metal element-doped garnet-type aluminate scintillator material is a polycrystal:
(1) weighing CeO₂, Al₂O₃, an oxide of RE, an oxide of D, and an oxide of M as raw materials in accordance with the chemical formula and mixing to obtain a mixed powder; and
(2) subjecting the mixed powder to solid phase reaction to give a transition metal element-doped garnet-type aluminate scintillation polycrystal, wherein a solid-phase reaction temperature is 1,200 to 2,000° C. and a solid-phase reaction time is 5 to 200 hours,
when the transition metal element-doped garnet-type aluminate scintillation material is a ceramic:
(1) weighing CeO₂, Al₂O₃, an oxide of RE, an oxide of D, and an oxide of M as raw materials according to the chemical formula and mixing to obtain a mixed powder; and
(2) forming the mixed powder into a green body and then sintering to obtain a transition metal element-doped garnet-type aluminate scintillation ceramic; wherein
a forming method of the green body includes dry pressing and/or cold isostatic pressing,
the dry pressing has a pressure of 10 to 35 MPa, and the cold isostatic pressing has a pressure of 2 to 5 Gpa,
the sintering is at least one of pressureless sintering, hot pressure sintering, and hot isostatic pressure sintering, and
a pressureless sintering temperature is 1,200 to 2,000° C., and a pressureless sintering time is 5 to 200 hours, and
when the transition metal element-doped garnet-type aluminate scintillator material is a single crystal:
(1) weighing CeO₂, Al₂O₃, an oxide of RE, an oxide of D, and an oxide of M as raw materials according to the chemical formula and mixing to obtain a mixed powder; and
(2) melting the mixed powder by heating and growing to give a single crystal, wherein
a growth method of the single crystal includes one of Czochralski method, Crucible Descent method, Temperature Gradient method, Heat Exchange method, Kyropoulos method, Top Seeded Solution Growth method, Flux Crystal Growth method, and Micro-Pulling-Down method, and
a heating method is resistance heating, electromagnetic induction heating, or optical heating.

6. The preparation method according to claim 5, further comprising subjecting the raw materials to pre-firing prior to the mixing, wherein
a pre-firing temperature is 1,100° C., and
a pre-firing time is 20 hours.

7. An application of a transition metal element-doped garnet-type aluminate scintillator material according to claim 1 in high energy physics, space physics, industrial non-destructive flaw detection, security auditing, mineral and oil well exploration, or nuclear medicine imaging.
